(19) United States
(12) Patent Application Publication
(10) Pub. No.: US 2018/0232135 A1
(43) Pub. Date: Aug. 16, 2018

(54) METHOD FOR WINDOW DISPLAYING ON A MOBILE TERMINAL AND MOBILE TERMINAL

(71) Applicants: Hisense Mobile Communications Technology Co., Ltd., Qingdao (CN); Hisense International Co., Ltd., Qingdao (CN); Hisense USA Corp., Suwanee, GA (US)

(72) Inventor: Lei Wang, Qingdao, Shandong (CN)

(73) Assignees: Hisense Mobile Communications Technology Co., Ltd., Qingdao (CN); Hisense International Co., Ltd., Qingdao (CN); Hisense USA Corp., Suwanee, GA (US)

(21) Appl. No.: 15/952,746

(22) Filed: Apr. 13, 2018

Related U.S. Application Data
(63) Continuation of application No. PCT/CN2016/074594, filed on Feb. 25, 2016.

(30) Foreign Application Priority Data
Oct. 16, 2015 (CN) 201510676658.9

(51) Int. Cl. G06F 3/0484

(52) U.S. Cl. CPC G06F 3/04847; G06F 3/0488

(57) ABSTRACT

Displaying a window on a mobile device includes acquiring a width value and a height value of a display screen, calculating a width value, a height value, and position information of a target window displayed within a display area of the display screen. The window display solution further includes acquiring a first window, setting attribute information of the first window according to the width and height values and the position information of the target window, setting control information of a drawing surface corresponding to the first window according to the attribute information, and controlling the mobile device to display original data of the drawing surface within the target window according to the control information.

### CROSS-REFERENCE TO RELATED APPLICATION(S)

This application is a Continuation of International Patent Application No. PCT/CN2016/074594 filed on Feb. 25, 2016, which claims priority to Chinese Patent Application No. 201510676658.9, filed on Oct. 16, 2015, titled “METHOD FOR WINDOW DISPLAYING AND MOBILE TERMINAL”, the entirety of all of which are hereby incorporated by reference herein.

### TECHNICAL FIELD

The present disclosure relates to the field of mobile terminal, and more particularly, to a method for window displaying on a mobile terminal and a mobile terminal.

### BACKGROUND

With the development of mobile terminal technology, a screen of a mobile phone becomes larger and larger. The size of the screen on some the mobile phones has already been increased from 5 inches to 7 inches by some mobile phone manufacturers. However, for users who are accustomed to one-handed operation, although a visual experience brought by a large-screen mobile phone is even better, it is difficult to implement one-handed operation on the large-screen mobile phone. In order to enable the users to perform one-handed operation on the large-screen mobile phone, a large window displayed in a full-screen may be scaled into a small window, and thus the users can complete all the operations with a single hand in the small window.

### SUMMARY

Some embodiments of the present disclosure provide a method for window displaying on a mobile terminal, where the method includes: acquiring a width value and a height value of a display screen of the mobile terminal; calculating a width value and a height value of a target window and position information of the target window on a display area of the display screen according to the width value and the height value of the display screen and a preset scaling ratio; acquiring a first window being displayed on a current interface of the mobile terminal; setting attribute information of the first window according to the width value and the height value of the target window and the position information of the target window on the display area of the display screen, wherein the attribute information includes a width value, a height value, and position information; setting control information of the drawing surface corresponding to the first window according to the attribute information; and controlling the mobile terminal to display original data of the drawing surface corresponding to the window on the target window according to the control information.

Some embodiments of the present disclosure provide a mobile terminal. The mobile terminal including: a memory including instructions stored thereon; and a processor configured to execute the instructions to: acquire a width value and a height value of a display screen of the mobile terminal; calculate a width value and a height value of a target window and position information of the target window on a display area of the display screen according to the width value and the height value of the display screen and a preset scaling ratio; acquire a first window being displayed on a current interface of the mobile terminal; set attribute information of the first window according to the width value and height value of the target window and the position information of the target window on the display area of the display screen, wherein the attribute information includes a width value, a height value, and position information; set control information of the drawing surface corresponding to the first window according to the attribute information; and control the mobile terminal to display original data of the drawing surface corresponding to the first window on the target window according to the control information.

Some embodiments of the present disclosure provide a non-transitory computer-readable storage medium storing executable instructions that, when executed by a mobile terminal, cause the mobile terminal to perform methods as described herein.

### BRIEF DESCRIPTION OF THE DRAWINGS

In order to describe embodiments of the present disclosure more clearly, the accompanying drawings to be used in the description of embodiments will be introduced briefly. Obviously, the accompanying drawings to be described below are merely some embodiments of the present disclosure, and a person of ordinary skill in the art can acquire other drawings according to those drawings without paying any creative effort.

FIG. 1 shows a flowchart of a method for window displaying on a mobile terminal according to some embodiments of the present disclosure;

FIG. 2 shows a flowchart of another method for window displaying on a mobile terminal according to some embodiments of the present disclosure;

FIG. 3 shows a schematic diagram of a first instruction according to some embodiments of the present disclosure;

FIG. 4 shows a schematic diagram of another first instruction according to some embodiments of the present disclosure;

FIG. 5 shows a schematic diagram of further another first instruction according to some embodiments of the present disclosure;

FIG. 6 shows a schematic diagram of a target window according to some embodiments of the present disclosure;

FIG. 7 shows a schematic diagram of another target window according to some embodiments of the present disclosure;

FIG. 8 shows a flowchart of further another method for window displaying on a mobile terminal according to some embodiments of the present disclosure;

FIG. 9 shows a flowchart of yet another method for window displaying on a mobile terminal according to some embodiments of the present disclosure;

FIG. 10 shows a flowchart of still further another method for window displaying on a mobile terminal according to some embodiments of the present disclosure;

FIG. 11 shows a schematic diagram of a second instruction according to some embodiments of the present disclosure;

FIG. 12 shows a schematic diagram of another second instruction according to some embodiments of the present disclosure;

FIG. 13 shows a schematic diagram of further another second instruction according to some embodiments of the present disclosure;

FIG. 14 shows a schematic diagram of a third instruction according to some embodiments of the present disclosure;

FIG. 15 shows a schematic diagram of further another target window according to some embodiments of the present disclosure;

FIG. 16 shows a schematic diagram of yet another target window according to some embodiments of the present disclosure;

FIG. 17 shows a schematic diagram of a composition of a mobile terminal according to some embodiments of the present disclosure;

FIG. 18 shows a schematic diagram of a composition of another mobile terminal according to some embodiments of the present disclosure;

FIG. 19 shows a schematic diagram of a composition of further another mobile terminal according to some embodiments of the present disclosure; and

FIG. 20 shows a schematic diagram of a composition of yet another mobile terminal according to some embodiments of the present disclosure.

### DETAILED DESCRIPTION

The embodiments of the present disclosure will be described clearly and completely with reference to the accompanying drawings in the embodiments of the present disclosure. Obviously, the described embodiments are merely some but not all of embodiments of the present disclosure. All other embodiments made on the basis of the embodiments of the present disclosure by a person of ordinary skill in the art without paying any creative effort shall fall within the protection scope of the present disclosure.

In related technologies, a method of scaling down a large window displayed in a full-screen to a small window for displaying includes following steps. A full-screen floating window is added at the top layer of a main screen, and bitmap information of a current screen is acquired through a screen capture. Then, the bitmap information is processed to be scaled down, and then the processed bitmap information is displayed in a designated area of the full-screen floating window, that is, a small window for displaying is achieved. In order to ensure that the content displayed in the small window is consistent with the content of the main screen, it is necessary to periodically capture a screen to acquire real-time bitmap information, and periodically update the content displayed in the small window.

However, if a frequency of a screen capture is too high, a lot of bitmap information will be stored in the memory. If the bitmap information in the memory cannot be released in time, the memory will be in a state of high occupancy rate for a long time, which affects user's experience. If the frequency of the screen capture is too low, the images displayed in the small window will be incoherent and get stuck.

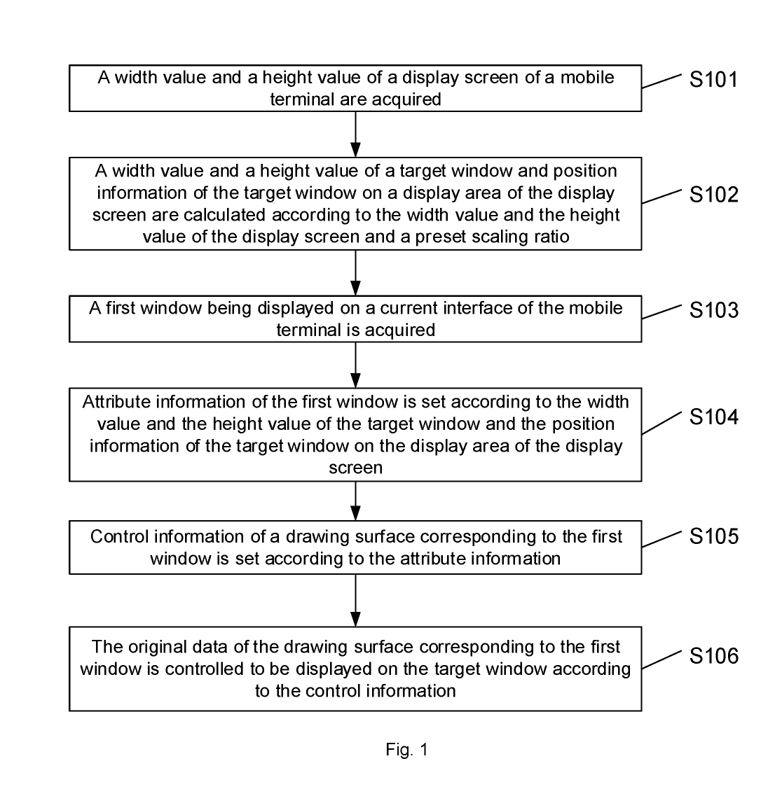

Regarding the problems above, some embodiments of the present disclosure provide a method for window displaying on a mobile terminal. As shown in FIG. 1, the method includes steps 101-106 (S101-S106). In some embodiments, the method is performed by a terminal. The method illustrated by FIG. 1 is implemented by instructions stored in a computer-readable storage medium.

In step 101 (S101), a width value and a height value of a display screen of the mobile terminal are acquired.

In some examples, the width value of the display screen is acquired by using the following code:

ScreenWidth=getWindowManager( ).getDefaultDisplay( ).getWidth( );

In some examples, the height value of the display screen is acquired by using the following code:

ScreenHeight=getWindowManager( ).getDefaultDisplay( ).getHeight( );

The width value and height value acquired above are in pixels.

In step 102 (S102), a width value and a height value of a target window and position information of the target window on a display area of the display screen are calculated according to the width value and the height value of the display screen and a preset scaling ratio.

The target window has a display area smaller than that of the display screen. For example, the display area of the target window is a rectangular area on the display screen. The scaling ratio, for example, is 0.75, 0.8, 0.85, or the like.

In some embodiments of the present disclosure, the target window is located in the bottom left corner or the bottom right corner of the display screen for the convenience of one-handed operation.

In step 103 (S103), a first window being displayed on a current interface of the mobile terminal is acquired.

In some embodiments, the current interface includes one first window, i.e., there is one window being displayed on the current interface. In other embodiments, the current interface includes a plurality of first windows, i.e., there are several windows being displayed on the current interface. In Android system, each of the first windows corresponds to a drawing surface. The drawing surface is simultaneously associated with a layer value and a block of memory. The drawing surface with a high layer is displayed above that with a low layer. For example, the mobile terminal is a mobile phone which has a startup interface including a wallpaper window and a window in which application icons are located, and the icons are displayed above the wallpaper.

In step 104 (S104), attribute information of the first window is set according to the width value and the height value of the target window and the position information of the target window on the display area of the display screen.

The attribute information includes a width value, a height value, and position information. The attribute information of the first window is set to ensure that the first window, after being scaled down, has a size the same as that of the target window, and the first window, after being scaled down, has a position that coincides with that of the target window.

In step 105 (S105), control information of a drawing surface corresponding to the first window is set according to the attribute information.

In some embodiments, data of the drawing surface corresponding to the first window is stored in a memory associated with the drawing surface. The data here includes, for example, control information and original data. The original data saves complete image information. The control information is used to control how the original data is displayed in the first window, for example, how to translate and how to scale.

In step 106 (S106), original data of the drawing surface corresponding to the first window is controlled to be displayed on the target window according to the control information.

In this way, the original data of the drawing surface corresponding to the first window is displayed on the target window, and a display area outside the target window, in which any content will not be displayed, is a blank area.

In the method for window displaying provided in the embodiments of the present disclosure, the width value and the height value of the target window and the position information of the target window on the display area of the display screen are determined according to the width value and the height value of the display screen of the mobile terminal and the preset scaling ratio. Furthermore, the mobile terminal is controlled to display the original data of the drawing surface corresponding to the first window on the target window, by modifying the control information of the drawing surface corresponding to the first window being displayed on the current interface. Compared with acquiring bitmap information periodically through the screen capture and periodically updating the content displayed on the target window, which result in the problems of high memory occupancy ratio and incoherent images, the embodiments of the present disclosure provide a solution which doesn't need any screen capture and add additional full-screen floating window and allows directly displaying the original data on the target window by modifying the control information, before the content to be displayed on the screen is generated. Therefore, the memory occupied is reduced, so that the problems of high memory occupancy rate and incoherent images may be avoided.

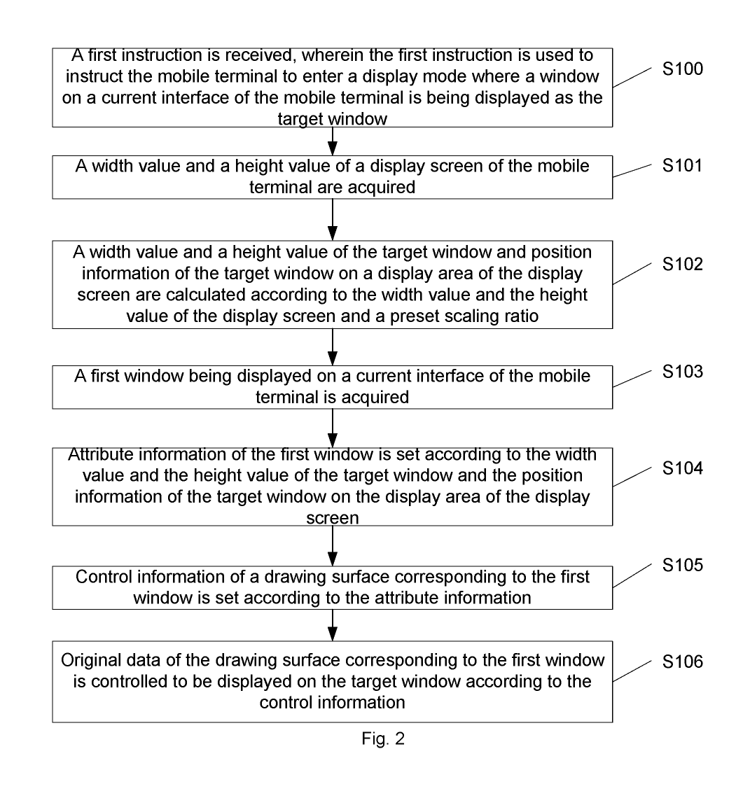

In some embodiments of the present disclosure, as shown in FIG. 2, before S101, the method for window displaying further includes step 100 (S100). The method illustrated in FIG. 2 is implemented by instructions stored in a computer-readable storage medium.

In step 100 (S100), a first instruction is received, wherein the first instruction is used to instruct the mobile terminal to enter a display mode where a window on a current interface of the mobile terminal is being displayed as the target window.

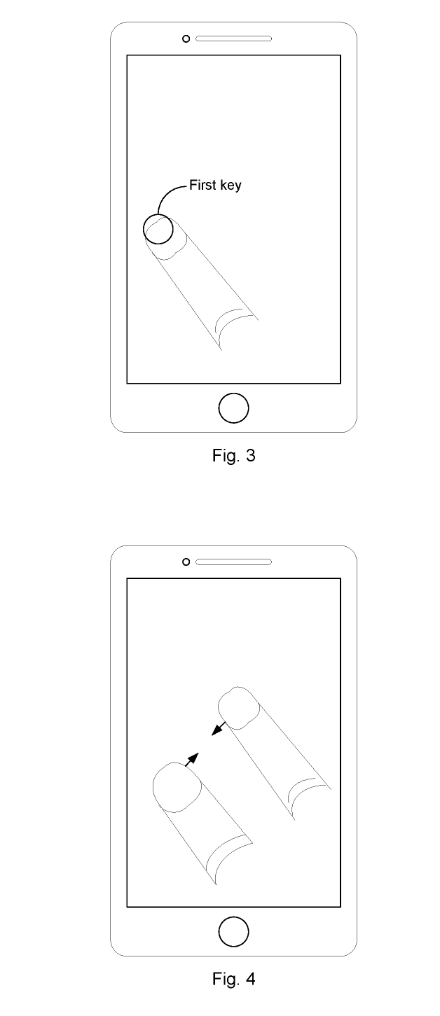

The first instruction is in the form of an operation, which includes one of following operations: clicking a first key, performing a first scaling gesture on the display screen, and shaking the mobile terminal a preset number of times. For example, referring to FIGS. 3-5, the keys are virtual ones displayed on the terminal's display screen.

In some embodiments, as shown in FIG. 3, the first instruction is the operation of clicking the first key. In some examples, the first key is a floating ball shown on the display screen. For example, coordinates of a touch point are acquired by listening for an ACTION_DOWN message, and whether a touch is the operation of clicking the first key is determined by determining whether these coordinates fall within the area where the floating ball is located.

In some other examples, as shown in FIG. 4, the first instruction is the operation of performing a first scaling gesture on the display screen. For example, whether a touch is an operation of the first scaling gesture is determined by detecting the trajectory of the touch point.

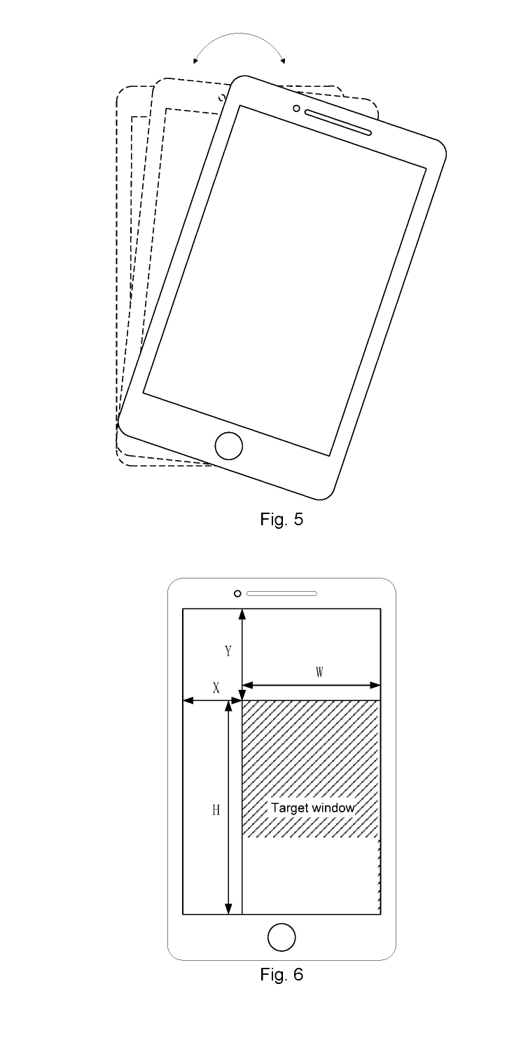

In still other embodiments, as shown in FIG. 5, the first instruction is the operation of shaking the mobile terminal a preset number of times. For example, the shaking condition of the mobile terminal is detected through an acceleration sensor or a gyro sensor in the mobile terminal.

In some embodiments of the present disclosure, the position information of the target window on the display area of the display screen includes a horizontal offset and a vertical offset.

In some examples, as shown in FIG. 6, the target window is located in the bottom right corner of the display screen. The horizontal offset (indicated by X) is an offset of a top left corner vertex of the target window relative to a top left corner vertex of the display screen in a horizontal direction. The vertical offset (indicated by Y) is an offset of the top left corner vertex of the target window relative to the top left corner vertex of the display screen in a vertical direction.

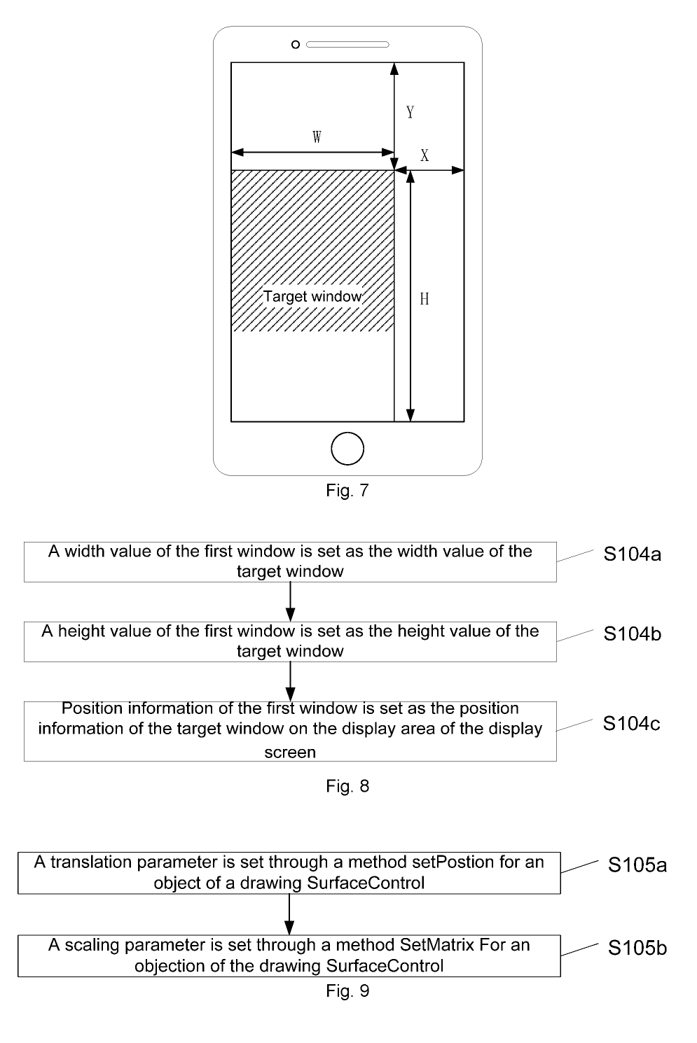

In some other examples, as shown in FIG. 7, the target window is located in the bottom left corner of the display screen. The horizontal offset (indicated by X) is an offset of a top right corner vertex of the target window relative to a top right corner vertex of the display screen in the horizontal direction. The vertical offset (indicated by Y) is an offset of the top right corner vertex of the target window relative to the top right corner vertex of the display screen in the vertical direction.

In some embodiments of the present disclosure, S102 includes calculating a width value of the target window, a height value of the target window, a horizontal offset and a vertical offset according to the following formulas.

W=W1×S (formula 1)

H=H1×S (formula 2)

X=W1−W1×S (formula 3)

Y=H1−H1×S (formula 4)

where, W is a width value of the target window, H is a height value of the target window, W1 is a width value of the display screen, H1 is a height value of the display screen, S is a scaling ratio, X is a horizontal offset, Y is a vertical offset, cross symbol × denotes a mathematical multiplication, and minus sign − denotes a mathematical subtraction.

In some embodiments of the present disclosure, as shown in FIG. 8, S104 includes steps 104a-104c (S104a-S104c). The method illustrated in FIG. 8 is implemented by instructions stored in a computer-readable storage medium.

In step 104a (S104a), a width value of the first window is set as the width value of the target window.

In step 104b (S104b), a height value of the first window is set as the height value of the target window.

In step 104c (S104c), position information of the first window is set as the position information of the target window on the display area of the display screen.

In some embodiments, the width value, the height value and the position information of the first window are set through a window state object corresponding to the first window.

In some embodiments of the present disclosure, as shown in FIG. 9, S105 includes steps 105a and 105b (S105a and S105b). The method illustrated in FIG. 9 is implemented by instructions stored in a machine-readable storage medium.

In S105a, a translation parameter is set through a method setPosition for an object of a drawing SurfaceControl.

In S105b, a scaling parameter is set through a method setMatrix for an object of the drawing SurfaceControl.

In some embodiments of the present disclosure, S106 includes scaling, synthesing and displaying the original data of the drawing surface corresponding to the first window on the target window by a SurfaceFlinger service according to the control information.

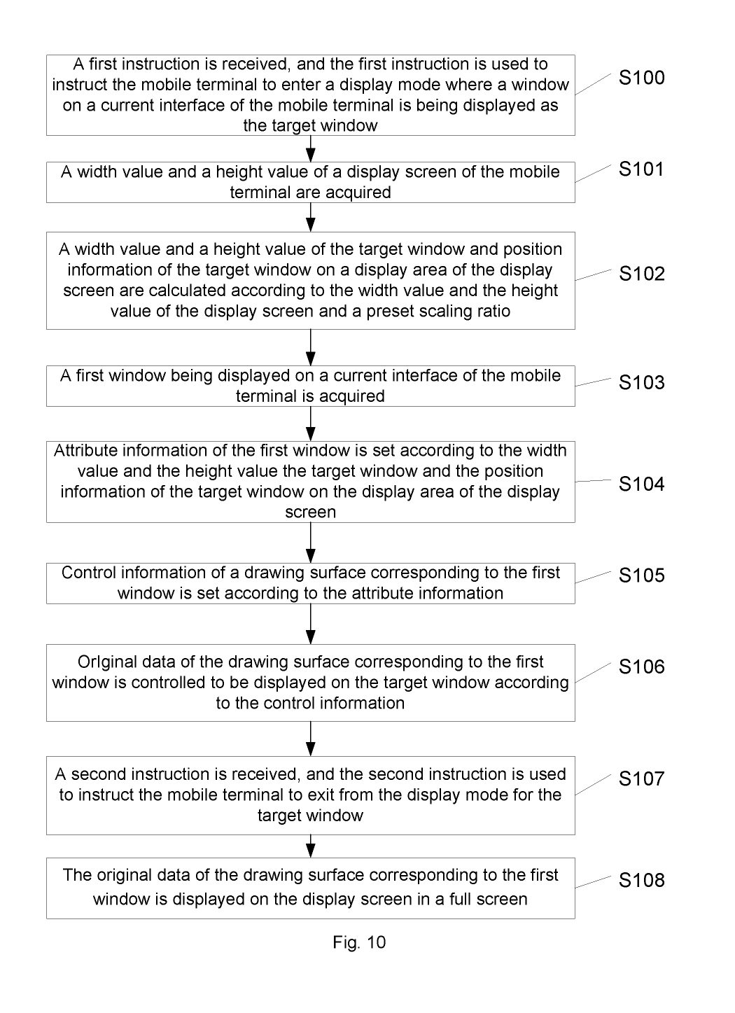

In some embodiments of the present disclosure, as shown in FIG. 10, if exiting from the display mode where the first window is being displayed as a target window, after S106, the method further includes steps 107 and 108 (S107-S108). The method illustrated in FIG. 10 is implemented by instructions stored in a computer-readable storage medium.

In S107, a second instruction is received, wherein the second instruction is an operation which indicates that the mobile terminal exits from the display mode for target window.

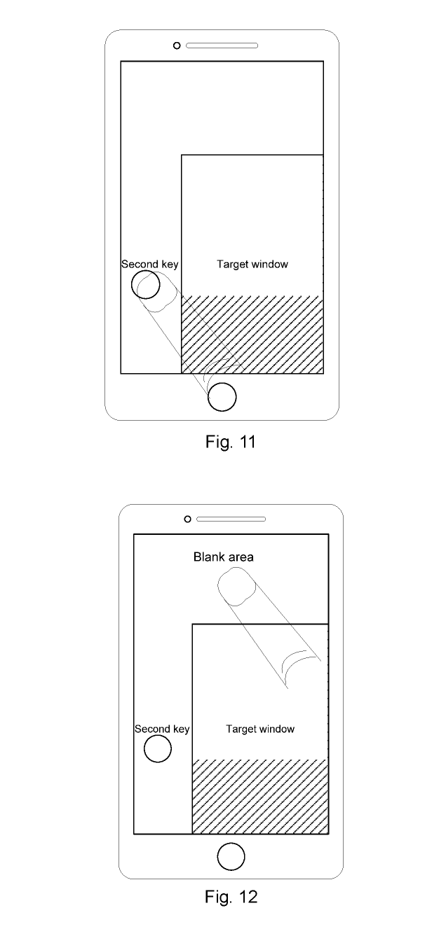

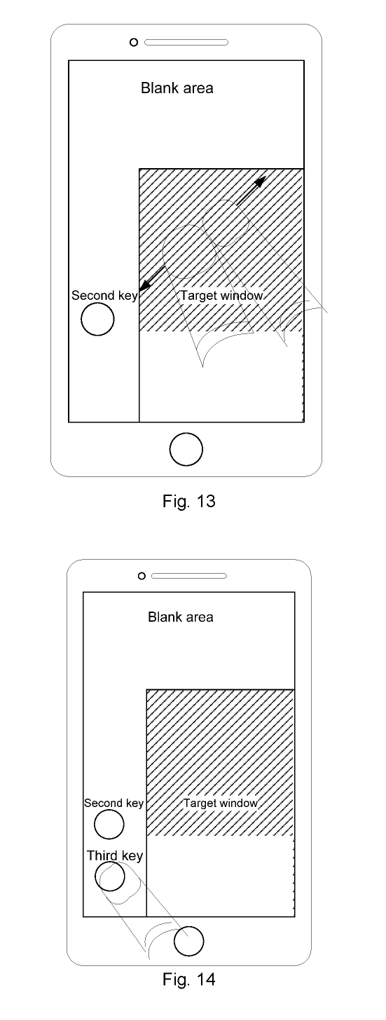

The second instruction is in the form of operations as follows: any one of an operation of clicking a second key, an operation of clicking a blank area of the display screen and an operation of performing a second scaling gesture on the display screen, referring to FIGS. 11-13.

In S108, the original data of the drawing surface corresponding to the first window is displayed on the display screen in a full screen.

The position and size of the target window are adjusted, for example, according to the user's operation. In some embodiments of the present disclosure, after S106, the method further includes that a third instruction is received, and the third instruction is used to instruct the mobile terminal to enter an editing mode where the target window is editable. The third instruction is in the form of an operation, for example, an operation of clicking a third key, referring to FIG. 14.

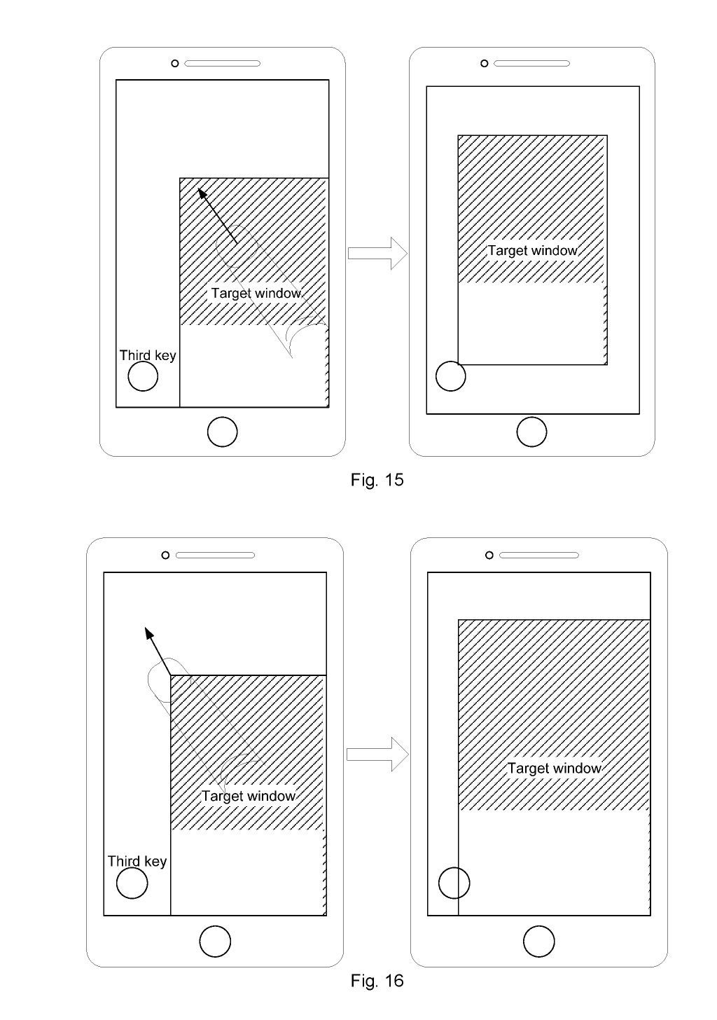

In some embodiments of the present disclosure, upon detecting a long press operation on the target window along with a slide operation, the target window is moved on the display screen according to a trajectory of the slide operation, referring to FIG. 15.

In some embodiments of the present disclosure, upon detecting a long press operation on any one of four corners of the target window with a slide operation, the target window is scaled along a moving direction of the slide operation, referring to FIG. 16.

According to the method for window displaying on a mobile terminal provided in the embodiments of the present disclosure, there is no need to take a screen capture and add an extra full-screen floating window on the display area of the screen, compared with the problems of periodically acquiring the bitmap information through the screen capture and periodically updating the content displayed on the target window, which result in a high memory occupancy ratio and incoherent images. The original data is directly displayed on the target window by modifying the control information, before the content to be displayed on the screen is generated. In this manner, the memory occupied is reduced, thereby avoiding high memory occupancy rate and incoherent images.

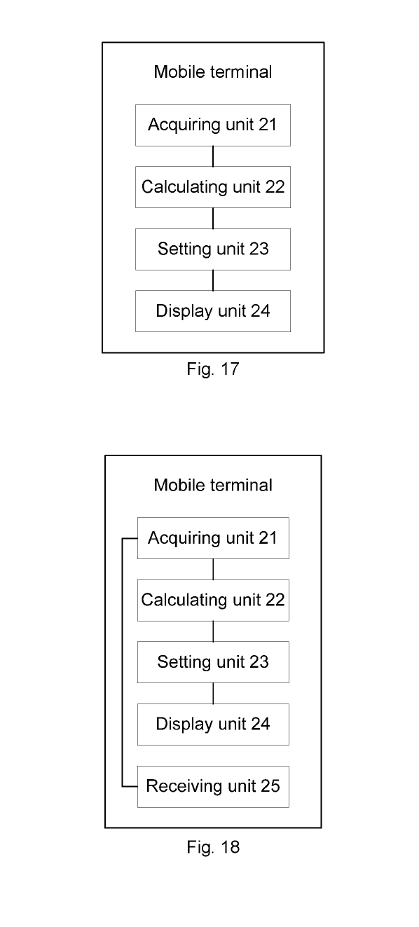

In addition, some embodiments of the present disclosure provide a mobile terminal. As shown in FIG. 17, the mobile terminal includes an acquiring unit 21, a calculating unit 22, a setting unit 23 and a display unit 24.

The acquiring unit 21 is configured to acquire a width value and a height value of a display screen of the mobile terminal. The calculating unit 22 is configured to calculate a width value and a height value of a target window and position information of the target window on a display area of the display screen according to the width and height values of the display screen acquired by the acquiring unit 21 and a preset scaling ratio.

The acquiring unit 21 is configured to acquire a first window being displayed on a current interface of the mobile terminal.

The setting unit 23 is configured to set attribute information of the first window according to the width and height values of the target window and the position information of the target window on the display area of the display screen calculated by the calculating unit 22. The attribute information includes a width value, a height value and position information.

The setting unit 23 is configured to set control information of a drawing surface corresponding to the first window according to the attribute information.

The display unit 24 is configured to control the mobile terminal to display original data of the drawing surface corresponding to the first window on the target window according to the control information.

In some embodiments of the present disclosure, as shown in FIG. 18, the mobile terminal further includes a receiving unit 25.

The receiving unit 25 is configured to, before the acquiring unit 21 acquires the width and height values of the display screen, receive a first instruction. The first instruction is used to instruct the mobile terminal to enter a display mode where a window on a current interface of the mobile terminal is being displayed as the target window. The first instruction includes one of following operations: clicking a first key, performing a first scaling gesture on the display screen and shaking the mobile terminal by a preset number of times.

In some embodiments of the present disclosure, the position information of the target window on the display area of the display screen includes a horizontal offset and a vertical offset.

The horizontal offset is an offset of a top left corner vertex of the target window relative to a top left corner vertex of the display screen in a horizontal direction and the vertical offset is an offset of the top left corner vertex of the target window relative to the top left corner vertex of the display screen in a vertical direction. Alternatively, the horizontal offset is an offset of a top right corner vertex of the target window relative to a top right corner vertex of the display screen in the horizontal direction and the vertical offset is an offset of the top right corner of the target window relative to the top right corner vertex of the display screen in the vertical direction.

In some embodiments of the present disclosure, the calculating unit 22 is configured to calculate the width value of the target window, the height value of the target window, the horizontal offset and the vertical offset by using the following four formulas.

The width value of the target window=the width value of the display screen×the scaling ratio.

The height value of the target window=the height value of the display screen×the scaling ratio.

The horizontal offset=the width value of the display screen−the width value of the display screen×the scaling ratio.

The vertical offset=the height value of the display screen−the height value of the display screen×the scaling ratio.

It should be noted that specific descriptions of some functional modules in the mobile terminal provided in the embodiments of the present disclosure may refer to corresponding contents in the method embodiments, which will not be described in detail in the embodiments.

In the mobile terminal provided in the embodiments of the present disclosure, the width and height values of the target window and the position information of the target window on the display area of the display screen are determined according to the width and height values of the display screen of the mobile terminal and the preset scaling ratio. Furthermore, the mobile terminal is controlled to display the original data of the drawing surface corresponding to the first window on the target window, by modifying the control information of the drawing surface corresponding to the first window being displayed on the current interface. Compared with acquiring bitmap information periodically through the screen capture and periodically updating the content displayed on the target window, which result in the problems of high memory occupancy ratio and incoherent images, the embodiments of the present disclosure provide a solution which does not need any screen capture and add additional full-screen floating window, and allows directly displaying the original data on the target window by modifying the control information, before the content to be displayed on the screen is generated. Therefore, the memory occupied is reduced, thereby avoiding the problems of high memory occupancy rate and incoherent images.

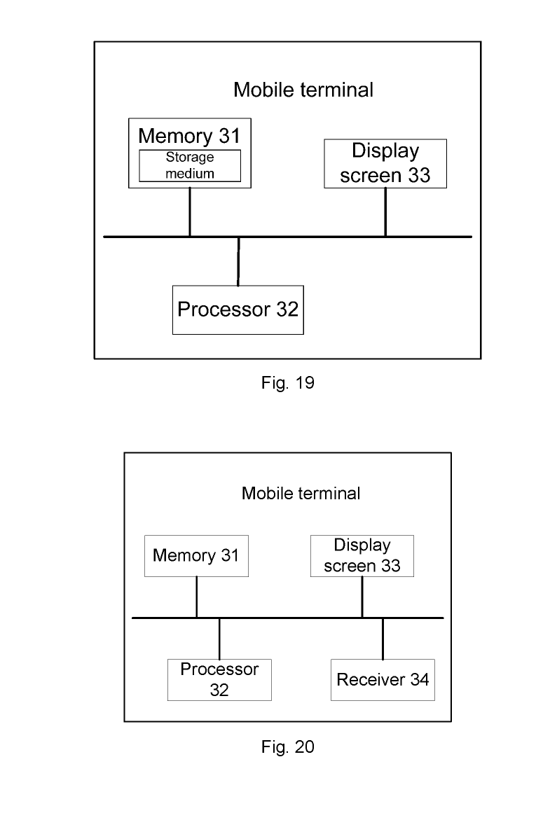

In addition, some embodiments of the present disclosure provide a mobile terminal. As shown in FIG. 19, the mobile terminal includes a memory 31 and a processor 32. In some embodiments, the mobile terminal also includes a display screen 33 in communication with the memory 31 and the processor 32.

The memory 31 is configured to store instructions. The processor 32 is configured to execute the instructions stored in the memory 31 to acquire a width value and a height value of a display screen 33 of the mobile terminal, and to calculate a width value and a height value of a target window and position information of the target window on the display area of the display screen according to the width and height values of the display screen 33 and a preset scaling ratio. In addition, the processor 32 is further configured to execute the instructions stored in the memory 31 to acquire a first window being displayed on a current interface of the mobile terminal, and to set attribute information of the first window according to the width and height values of the target window and the position information of the target window on the display area of the display screen 33. The attribute information includes a width value, a height value, and position information. Besides, the processor 32 is further configured to execute the instructions stored in the memory 31 to set control information of a drawing surface corresponding to the first window according to the attribute information. The display screen 33 is configured to display original data of the drawing surface corresponding to the window on the target window according to the control information.

In some embodiments of the present disclosure, as shown in FIG. 20, the mobile terminal further includes a receiver 34. The receiver 34 is configured to, before the width and height values of the display screen 33 are acquired by the processor 32, receive a first instruction. The first instruction is used to instruct the mobile terminal to enter a display mode where a window on a current interface of the mobile terminal is being displayed as the target window. The first instruction includes one of following operations: clicking a first key, performing a first scaling gesture on the display screen and shaking the mobile terminal by a preset number of times.

In some embodiments of the present disclosure, the position information of the target window on the display area of the display screen 33 includes a horizontal offset and a vertical offset.

In some examples, the horizontal offset is an offset of a top left corner vertex of the target window relative to a top left corner vertex of the display screen 33 in a horizontal direction, and the vertical offset is an offset of the top left corner vertex of the target window relative to the top left corner vertex of the display screen 33 in a vertical direction. In some other examples, the horizontal offset is an offset of a top right corner vertex of the target window relative to a top right corner vertex of the display screen 33 in the horizontal direction, and the vertical offset is an offset of the top right corner vertex of the target window relative to the top right corner vertex of the display screen 33 in the vertical direction.

In some embodiments of the present disclosure, the processor 32 is configured to calculate the width value of the target window, the height value of the target window, the horizontal offset and the vertical offset by using the following four formulas.

The width value of the target window=the width value of the display screen 33×the scaling ratio;

The height value of the target window=the height value of the display screen 33×the scaling ratio;

The horizontal offset=the width value of the display screen 33−the width value of the display screen 33×the scaling ratio;

The vertical offset=the height value of the display screen 33−the height value of the display screen 33×the scaling ratio.

It should be noted that specific descriptions of some entity modules in the mobile terminal provided in the embodiments of the present disclosure refer to corresponding contents in the method embodiments, which will not be described in detail in the embodiments.

In the mobile terminal provided in the embodiments of the present disclosure, the width and height values of the target window and the position information of the target window on the display area of the display screen are determined according to the width and height values of the display screen of the mobile terminal and the preset scaling ratio. In addition, the mobile terminal is controlled to display the original data of the drawing surface corresponding to the window on the target window, by modifying the control information of the drawing surface corresponding to the window being displayed on the current interface. Compared with acquiring bitmap information periodically through the screen capture and periodically updating the content displayed on the target window, which result in the problems of high memory occupancy ratio and screen incoherent images, the embodiments of the present disclosure provide a solution which does not need any screen capture and add additional full-screen floating window, and allow directly displaying the original data on the target window by modifying the control information, before the content to be displayed on the screen is generated. Therefore, the memory occupied is reduced, thereby avoiding the problems of high memory occupancy rate and incoherent images.

One person skilled in the art can clearly understand that, for convenience and brevity of description, the above-described device is only illustrated by the above-mentioned modules. In practical applications, the above functions may be achieved by different modules according to needs. For specific working processes of the above-described systems, apparatuses, and units, reference is made to corresponding processes in the foregoing method embodiments, and details are not described herein again. The specific working processes of the above-described systems, apparatuses, and units refer to corresponding processes in the foregoing method embodiments, and details are not described herein again.

In the above embodiments provided in the present disclosure, it should be understood that the disclosed system, apparatus, and method may be implemented in other manners. For example, the embodiments of the apparatus described above are merely exemplary. For example, multiple units or components can be combined or can be integrated into another system, or some features can be ignored or can't be executed. In addition, the shown or discussed mutual coupling or direct coupling or communication connection can be indirect coupling or communication connection through some interfaces, devices or units, and can be of electrical, mechanical or other forms.

The units described as separate components are or are not physically separated. The components displayed as units are or are not physical units, that is, may locate in one place or may also be distributed on multiple network units. Some or all of the units may be selected according to actual needs to achieve the objectives of the solutions in these embodiments.

In addition, each unit in each embodiment of the present disclosure may be integrated in one processing unit, or each unit may be independent of other units, or two or more units may be integrated in one processing unit. Above integrated unit can be implemented in the form of hardware or in the form of hardware plus software unit.

The integrated unit, if implemented in the form of a software unit and sold or used as a stand-alone product, may be stored in a computer-readable storage medium. Above software unit is stored in a storage medium and includes one or more instructions for enabling a computer device (which may be a personal computer, a server, or a network device) to perform part or all of steps of the method according to each embodiment of the present disclosure. The storage medium includes various types of medium that can store program codes, such as a USB flash drive, a removable hard disk, a Read-Only Memory (ROM), a Random-Access Memory (RAM), a magnetic disk.

The foregoing descriptions are merely specific implementation manners of the present disclosure, but the protection scope of the present disclosure is not limited thereto. Any person skilled in the art may easily think of the change or the replacement within the technical scope disclosed in the present disclosure, which should be within the scope of the disclosure. Therefore, the protection scope of the present disclosure should be based on the protection scope of the claims.

What is claimed is:

1. A method for displaying a window on a mobile device, comprising:
acquiring a width value and a height value of a display screen of the mobile device;
calculating a width value and a height value of a target window within a display area of the display screen;
determining position information of the target window within the display area of the display screen according to the width value and the height value of the display screen and a preset scaling ratio;
acquiring a first window being displayed on a current interface of the mobile device;
setting attribute information of the first window to include the width value and the height value of the target window and the position information of the target window within the display area of the display screen;
setting control information of a drawing surface corresponding to the first window according to the attribute information; and
controlling the mobile device to display original data of the drawing surface corresponding to the first window on the target window according to the control information.

2. The method according to claim 1, wherein before acquiring the width value and the height value of the display screen of the mobile device, the method further comprises:
receiving a first instruction, wherein the first instruction is used to instruct the mobile device to enter a display mode where a window on a current interface of the mobile device is being displayed as the target window, and the first instruction comprises one of following operations: receiving an input via a first key, receiving an input corresponding to a first scaling gesture on the display screen, or receiving an input corresponding to shaking of the mobile device a preset number of times.

3. The method according to claim 1, wherein the position information of the target window within the display area of the display screen comprises a horizontal offset and a vertical offset; and
the horizontal offset is:
an offset of a top left corner vertex of the target window relative to a top left corner vertex of the display screen in a horizontal direction, and the vertical offset is an offset of the top left corner vertex of the target window relative to the top left corner vertex of the display screen in a vertical direction; or
an offset of a top right corner vertex of the target window relative to a top right corner vertex of the display screen in the horizontal direction, and the vertical offset is an offset of the top right corner vertex of the target window relative to the top right corner vertex of the display screen in the vertical direction.

4. The method according to claim 3, wherein calculating the width value and the height value of the target window and the position information of the target window on the display area of the display screen, comprises:
calculating the width value of the target window to be a product of the width value of the display screen and the preset scaling ratio;
calculating the height value of the target window to be a product of the height value of the display screen and the preset scaling ratio;
calculating the horizontal offset to be a difference between the width value of the display screen and a product of the width value of the display screen and the preset scaling ratio; and
calculating the vertical offset to be a difference between the height value of the display screen and a product of the height value of the display screen and the preset scaling ratio.

5. The method according to claim 1, wherein setting the attribute information of the first window to include the width value and the height value of the target window and the position information of the target window within the display area of the display screen, comprises:
setting a width value of the first window as the width value of the target window;
setting a height value of the first window as the height value of the target window; and
setting position information of the first window as the position information of the target window within the display area of the display screen.

6. The method according to claim 1, wherein, after controlling the mobile device to display the original data of the drawing surface corresponding to the first window on the target window according to the control information, the method further comprises:
receiving a second instruction, wherein the second instruction is used to instruct the mobile device to exit from a display mode where a window on a current interface of the mobile device is being displayed as the target window, and the second instruction comprises one of following operations: receiving an input via a second key, receiving an input via a blank area of the display screen, or receiving an input corresponding to a second scaling gesture on the display screen; and
displaying, on the display screen, the original data of the drawing surface corresponding to the first window in a full screen.

7. The method according to claim 1, wherein after controlling the mobile device to display the original data of the drawing surface corresponding to the first window on the target window according to the control information, the method further comprises:
receiving a third instruction, wherein the third instruction is used to instruct the mobile device to enter an editing mode where the target window is editable, and the third instruction comprises receiving an input via a third key.

8. The method according to claim 7, further comprising:
upon detecting a long press operation input within the target window along with a slide operation, moving the target window on the display screen according to a trajectory of the slide operation.

9. The method according to claim 7, further comprising:
upon detecting a long press operation input on any one corner of the target window along with a slide operation, scaling the target window along a moving direction of the slide operation.

10. A mobile device, comprising:
a memory including instructions stored thereon; and
a processor configured to execute the instructions to:
acquire a width value and a height value of a display screen of the mobile device;
calculate a width value and a height value of a target window within a display area of the display screen;
determine position information of the target window within the display area of the display screen according to the width value and the height value of the display screen and a preset scaling ratio;
acquire a first window being displayed on a current interface of the mobile device;
set attribute information of the first window to include the width value and the height value of the target window and the position information of the target window within the display area of the display screen;
set control information of a drawing surface corresponding to the first window according to the attribute information; and
control the mobile device to display original data of the drawing surface corresponding to the first window on the target window according to the control information.

11. The mobile device according to claim 10, further comprising a receiver configured to:
before the processor acquires the width value and the height value of the display screen, receive a first instruction, wherein the first instruction is used to instruct the mobile device to enter a display mode where a window on a current interface of the mobile device is being displayed as the target window, and the first instruction comprises one of following operations: receiving an input via a first key, receiving an input corresponding to a first scaling gesture on the display screen, or receiving an input corresponding to shaking of the mobile device a preset number of times.

12. The mobile device according to claim 10, wherein, the position information of the target window on the display area of the display screen comprises a horizontal offset and a vertical offset; and
the horizontal offset is:
an offset of a top left corner vertex of the target window relative to a top left corner vertex of the display screen in a horizontal direction, and the vertical offset is an offset of the top left corner vertex of the target window relative to the top left corner vertex of the display screen in a vertical direction; or
an offset of a top right corner vertex of the target window relative to a top right corner vertex of the display screen in the horizontal direction, and the vertical offset is an offset of the top right corner vertex of the target window relative to the top right corner vertex of the display screen in the vertical direction.

13. The mobile device according to claim 12, wherein the processor is configured to execute the instruction to calculate the width value of the target window, the height value of the target window, the horizontal offset and the vertical offset by:
calculating the width value of the target window to be a product of the width value of the display screen and the preset scaling ratio;
calculating the height value of the target window to be a product of the height value of the display screen and the preset scaling ratio;
calculating the horizontal offset to be a difference between the width value of the display screen and a product of the width value of the display screen and the preset scaling ratio; and
calculating the vertical offset to be a difference between the height value of the display screen and a product of the height value of the display screen and the preset scaling ratio.

14. The mobile device according to claim 10, wherein the processor is configured to execute the instructions to set the attribute information of the first window according to the width value and the height value of the target window and the position information of the target window within the display area of the display screen by:
setting a width value of the first window as the width value of the target window;
setting a height value of the first window as the height value of the target window; and
setting position information of the first window as the position information of the target window on the display area of the display screen.

15. The mobile device according to claim 10, further comprising a receiver configured to, after the processor controls the mobile device to display the original data of the drawing surface corresponding to the first window on the target window according to the control information:
receive a second instruction, wherein the second instruction is used to instruct the mobile device to exit from a display mode where a window on a current interface of the mobile device is being displayed as the target window, and the second instruction comprises one of following operations: receiving an input via a second key, receiving an input via a blank area of the display screen, or receiving an input corresponding to a second scaling gesture on the display screen; and
display, on the display screen, the original data of the drawing surface corresponding to the first window in a full screen.

16. The mobile device according to claim 10, further comprising a receiver configured to, after the processor controls the mobile device to display the original data of the drawing surface corresponding to the first window in the target window according to the control information:
receive a third instruction, wherein the third instruction is used to instruct the mobile device to enter an editing mode where the target window is editable, and the third instruction comprises receiving an input via a third key.

17. The mobile device according to claim 16, wherein the processor is further configured to execute the instructions to:
upon detecting a long presses operation input within the target window along with a slide operation, move the target window on the display screen according to a trajectory of the slide operation.

18. The mobile device according to claim 10, wherein the processor is further configured to execute the instructions to:
upon detecting a long presses operation on any one corner of the target window along with a slide operation, scale the target window along a moving direction of the slide operation.

19. A non-transitory computer-readable storage medium storing executable instructions that, when executed by a mobile device, cause the mobile device to:
acquire a width value and a height value of a display screen of the mobile device;
calculate a width value and a height value of a target window within a display area of the display screen;
determine position information of the target window within the display area of the display screen according to the width value and the height value of the display screen and a preset scaling ratio;
acquire a first window being displayed on a current interface of the mobile device;
set attribute information of the first window to include the width value and the height value of the target window and the position information of the target window within the display area of the display screen;
set control information of a drawing surface corresponding to the first window according to the attribute information; and
control the mobile device to display original data of the drawing surface corresponding to the first window on the target window according to the control information.
